(19) United States
(12) Patent Application Publication
(10) Pub. No.: US 2004/0070334 A1
(43) Pub. Date: Apr. 15, 2004

(54) Encapsulated electrode

(76) Inventors: Alastair Robert Buckley, Edinburgh (GB); Christopher Ian Wilkinson, Penicuik (GB); David George Lidzey, Sheffield (GB)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 10/469,089

(22) PCT Filed: Feb. 27, 2002
(86) PCT No.: PCT/GB02/00875

(30) Foreign Application Priority Data
Feb. 28, 2001 (GB) 01049618

(51) Int. Cl. H05B 33/02

(52) U.S. Cl. 313/504; 313/500

(57) ABSTRACT

An organic electroluminescent device includes a two-layer transparent electrode structure comprising a transparent layer 15 of 5-50 nm thickness of reactive material with a work function less than 4 eV, such as calcium, and a transparent layer 16 of electrically inert metal halide material, such as lithium fluoride.

### BACKGROUND OF THE INVENTION

This invention relates to an encapsulated electrode for an organic electroluminescent device.

Recently, active research on organic electroluminescent devices has led to improvements in the device efficiencies, and operating lifetimes of the devices. Some of the contributing factors to the rapid improvement in device performances have come from new materials that have optimized properties. This has led to improved hole and electron transport, as well as improved electroluminescence, and added robustness to degradation in an electric field.

Further improvements have been achieved by matching the work function of the anode and cathode to those of the organic materials in direct contact with the respective electrodes. This lowers the barrier height between the lowest unoccupied molecular orbital (LUMO) of the organic material and the cathode, and similarly for the highest occupied molecular orbital (HOMO) of the organic material and the anode.

This has proved more problematic for the metal cathode as the external quantum efficiency of the device increases with the use of a layer of low work function metal as a cathode, where low work function is <4 eV. Typically lithium, calcium and magnesium have shown good performance. Calcium and lithium are particularly effective when used with polymer organic materials as the metal intercalates into the polymer on deposition creating a doped interface region that is efficient for electron transport and injection. However, these are readily reactive metal electrode materials in an air atmosphere, and degrade rapidly unless efficient encapsulation from moisture and oxygen is provided.

The use of high work function metals, or conductive metal oxides as an anode, where high work function is >4 eV, is less problematical as these are generally stable in air atmosphere. Indium tin oxide (ITO) is often used as it can be deposited and patterned on glass creating a transparent anode.

To improve the cathode electron injection properties and produce more stable cathode structures the use of composite cathode structures has been attempted. Silver-magnesium (Mg_{0.9}Ag_{0.1}) alloy has been used as has aluminum lithium alloy (Al Li). However these electrode structures still show signs of deleterious oxidation on prolonged usage.

Another method of improving the cathode has been to deposit a very thin layer of insulating material between the metal and the organic material layer. The layer thickness requires to be very carefully controlled and is typically <1 nm. This has generally been used with an air stable metal such as aluminum. Lithium fluoride (LiF) has been used with aluminum and other metals, while cesium fluoride (CsF), silicon dioxide, sodium fluoride and aluminum oxide have also been used with aluminum and show improvement in external efficiency when compared to a single layer aluminum electrode.

A further improvement was found where the insulator was co-deposited with a metal. By co-depositing lithium fluoride with aluminum to form a composite layer of typically between 50-200 nm, the external efficiency was reported to improve when compared to a device having a LiF buffer layer and aluminum cathode structure. The manufacture was also simplified as the composite layer thickness is less critical than for a buffer layer.

Thus, FIG. 1 shows a device comprising a glass substrate 1, on which there has been deposited in turn a layer of ITO 2, a hole transport layer 3, an organic electroluminescent layer 4, a layer of LiF 5 and a layer of aluminum 6.

However, these bi-layer and composite structures still have higher work functions than lithium, calcium or similar, and are therefore still electrically an inferior contact. See L. S. Hung et al, “Enhanced electron injection in organic electroluminescence devices using an Al/LiF electrode”, Applied Physics Letters 70 (2), 13 Jan. 1997, and G. E. Jabbour et al, “Aluminum Composite Cathodes”, Optics & Photonics News, April 1999.

In all cases, the cathode requires further encapsulation to exclude water and oxygen from contacting, or migrating into, the reactive metal(s) or the organic layers which leads to decreased performance and device lifetimes.

Further difficulties arise in achieving an efficient, encapsulated cathode structure if it is also required to be transparent, as can occur when the organic electroluminescent device is manufactured on an opaque substrate such as a silicon wafer or certain plastic substrates, and for a fully transparent display, which may use a transparent plastic or glass substrate.

In a typical device structure a glass substrate is used onto which a transparent electrode (anode) is deposited, typically of ITO or the like. A number of organic layers are formed on this anode consisting of some or all of a hole transporting layer, a light emitting layer and an electron transporting layer. A second electrode (cathode) is formed by one of the methods described above. This is then further capped by a thicker layer of air stable metal such as aluminum, which is opaque and encapsulates the electrode and organic layers. Light can then be emitted through the transparent anode/substrate.

To realize a transparent cathode structure a thin (10 nm or less) layer of a low work function metal such as Ca has been used onto which was deposited a transparent conducting film of ITO. However this has the disadvantage of placing an oxygen rich species, ITO, next to an oxygen sensitive metal, and oxygen from the ITO can diffuse towards the metal decaying the quality of the electrical connection. The process of depositing ITO is also a harsh high temperature process, and often requires an annealing step, typically at greater than 200° C., in an oxygen rich environment where the oxygen content of the metal oxide is adjusted upwards to attain suitably transparent, conducting films. The temperatures and oxygen rich environments can be damaging to the organic layer(s) and the low work function metals.

More recently an efficient method of creating a transparent encapsulant for an electrode has been reported. This involves the use of multi-layer structure consisting of layers of polymer and high density dielectric materials. While good device lifetimes have been reported the structures and materials used have not been widely reported. Such a multi-layer design may offer efficient encapsulation but adds complexity to the device manufacture.

### SUMMARY OF THE INVENTION

It is an object of the present invention to provide an efficient encapsulation for a transparent electrode structure for an electroluminescent display in which the encapsulant has the added advantage of improving device efficiency by aiding charge injection from the electrode.

The invention provides an organic electroluminescent device including a two-layer transparent electrode structure, comprising a transparent layer of 5-50 nm thickness of reactive material with a work function less than 4 eV, and a transparent layer of electrically inert metal halide material.

The invention uses a thin layer of calcium (or similar low work function metal) typically of thicknesses that can range from 5 to 50 nm, so that this layer is primarily transparent and allows for the emitted light to be viewed through the calcium. The thickness is carefully controlled, with films of about 10 nm thickness approaching the maximum optimization in terms of electrical performance and transparency.

A layer of lithium fluoride (LiF) or other metal halide is then deposited directly on top of the low work function reactive metal. This lithium fluoride layer is typically of the order of 50 to 500 nm in thickness. LiF has the highest band gap energy of any fluoride material, 12 eV, and therefore acts as an extremely insulating, stable, transparent primary encapsulant, protecting the calcium from oxygen ingress and moisture. LiF is reactive with moisture, however the thickness of the layer prevents any moisture penetrating through to the underlying calcium.

Furthermore, the addition of the LiF layer on top of the calcium is seen to further enhance the external efficiency of the electroluminescent device, when compared to an exactly similar device that does not have the LiF encapsulant.

The LiF interacts with the calcium layer thereby improving charge injection and may also be diffusing through the calcium to form a complex electrode structure at the interface with the organic material. The LiF fills any pinholes in the calcium layer providing a more complete and efficient electron injecting structure.

Whilst the thickness of the LiF layer has the added advantage of providing a primary encapsulation barrier, it is not intended to be the sole encapsulant of the cathode and underlying organic layers. The primary encapsulant, LiF, is deposited after the calcium electrode but whilst still under a continuous vacuum.

The devices can be transferred from a vacuum environment into an inert nitrogen environment for further encapsulation. A standard method of further encapsulation is to attach, using epoxy resin, a sheet of transparent glass over the active display area of the electroluminescent device. This procedure is normally conducted in a controlled environment, such as a nitrogen filled glove box. LiF has the added benefit of being inert to several standard glues and epoxy resins.

Preferably, the device includes an anode formed from a material having a work function greater than 4 eV. The substrate can be formed from glass, plastics or silicon and in a particular embodiment the substrate comprises a CMOS silicon wafer. Preferably, a plurality of pixels can be actively addressed from the substrate.

### BRIEF DESCRIPTION OF THE DRAWINGS

To further aid the understanding of the process and benefits of our invention reference will now be made, by way of example only, to the accompanying drawings, in which:

FIG. 1 is a schematic cross section through the prior art device discussed above; and

FIG. 2 is a schematic cross section through a device according to an embodiment of the invention.

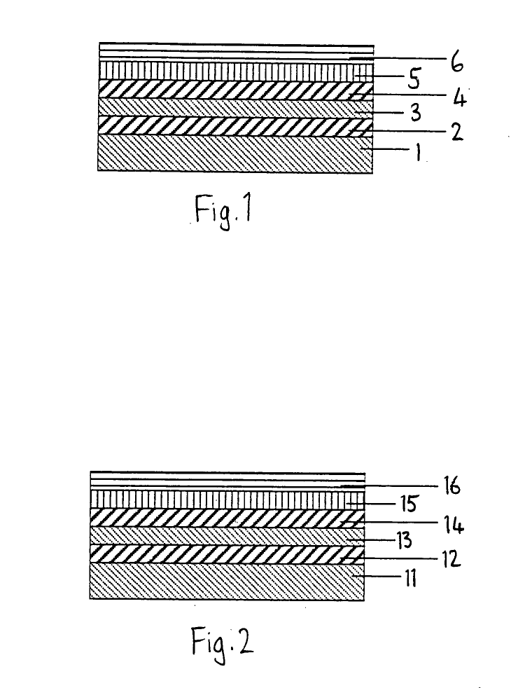

### DETAILED DESCRIPTION OF THE PREFERRED EMBODIMENTS

A device substrate 11 is suitably cleaned. The cleaning process may alter depending on whether the substrate is glass, a silicon wafer, or plastic. Cleaning methods and procedures are known to those skilled in the art. In this example the substrate is glass that is cleaned using a degreasing agent such as Decon in an ultrasonic bath for 10 minutes. The substrate is then cleaned with de-ionized water in an ultrasonic bath for a further 10 minutes. The substrate is then further cleaned in methanol in an ultrasonic bath, and dried in a nitrogen gas stream. An anode material 12 is then deposited. For example aluminum would be evaporated at a base pressure of 3×10⁻⁶ mbar at 1 to 5 A/s to a thickness of about 100 nm. The vacuum is released and a conducting polymer 13 is spin-coated onto the aluminum. For example, poly(ethylendioxythiophene) (PEDOT) is spun at 5000 rpm for 30 seconds resulting in a film of approximately 30 nm. The PEDOT film 13 is dried to remove residual solvent by baking in air at 120° C. for 20 minutes. An electroluminescent polymer 14 is then spin-coated at sufficient speed and time to yield a film of approximately 70 nm. Typically using a polymer solution of 25 g/l this would be at 3000 rpm for 30 seconds.

The device is then transferred to a glove box nitrogen environment with less than 2 ppm oxygen and 5 ppm water present. Within the nitrogen environment the sample device is transferred into a vacuum oven and baked in a vacuum for 30 min at 70° C., before being cooled and re-introduced to a nitrogen atmosphere. The device is then transferred whilst still under a nitrogen atmosphere to a thin film deposition system for calcium and lithium fluoride deposition.

Calcium 15 is evaporated at a base pressure of 3×10⁻⁶ mbar at a controlled rate of 0.2 to 0.5 A/s to a desired film thickness of between 5 to 50 nm. Without altering the system pressure, lithium fluoride 16 is then deposited in an analogous fashion at an increased rate ranging between 1 to 5 A/s to a desired film thickness. Films ranging from 50 nm to 500 nm appear suitable. We have found LiF film thicknesses of 200 nm to be satisfactory for primary encapsulation and transparency. However, it is possible that films of any thickness above 10 nm may be suitable. The performance of the LiF film 16 as an electrode efficiency enhancer and encapsulant is dependent on the conditions of the deposition process.

Having completed the electrode structure and primary encapsulation of the device, the sample device can be transferred back to the controlled nitrogen environment to complete device encapsulation by attaching an oxygen and moisture impermeable glass barrier.

The use of LiF to improve the electron injecting efficiency of a transparent electrode and serve as primary encapsulant of the electrode has been detailed here for use with a transparent calcium layer. However it would be suitable to perform a similar function with any reactive metal, or metal-oxide electrode material. Examples of other reactive electrode materials that it would be useful to use LiF with include lithium, cesium and calcium oxide.

Similarly, it would appear possible to use materials which have similar properties to LiF as the efficiency enhancing electrode material and primary encapsulant. Such similar materials include calcium fluoride, magnesium fluoride, cesium fluoride, lithium chloride or other stable metal halide materials or mixtures thereof.

1. An organic electroluminescent device including a two-layer transparent electrode structure comprising a transparent layer of 5-50 nm thickness of reactive material with a work function less than 4 eV, and a transparent layer of electrically inert metal halide material.

2. A device as claimed in claim 1, wherein the reactive low work function material is calcium.

3. A transparent electrode structure as claimed in claim 1, wherein the reactive low work function material is selected from one of lithium, cesium and calcium oxide.

4. A device as claimed in claim 1, 2 or 3, wherein the inert metal halide material is lithium fluoride.

5. A device as claimed in claim 1, 2 or 3, wherein the inert metal halide material is selected from calcium fluoride, cesium fluoride, magnesium fluoride, or lithium chloride.

6. A device as claimed in claim 1, 2 or 3, wherein the inert metal halide layer is made from a mixture of inert metal halides.

7. A device as claimed in any preceding claim, including an anode formed from a material having a work function greater than 4 eV.

8. A device as claimed in any preceding claim, comprising a substrate made of glass, plastics or silicon.

9. A device as claimed in claim 8, wherein the substrate comprises a CMOS silicon wafer.

10. A device as claimed in any preceding claim, including a plurality of pixels that can be actively addressed from the substrate.
